(19) United States
(12) Patent Application Publication
(10) Pub. No.: US 2025/0376885 A1
(43) Pub. Date: Dec. 11, 2025

(54) PIVOT SUPPORT SYSTEM FOR LIFT ASSIST OF A CLOSURE

(71) Applicant: Rivian IP Holdings, LLC, Irvine, CA (US)

(72) Inventors: William Kirk ROBINSON, Newport Beach, CA (US); Shreyas SANSUDDI, Long Beach, CA (US); Marcus Edward MERIDETH, Irvine, CA (US)

(21) Appl. No.: 18/736,356

(22) Filed: Jun. 6, 2024

(51) Int. Cl. E05F 15/54

(52) U.S. Cl. CPC E05F 15/54; E05Y 2201/626; E05Y 2600/32; E05Y 2600/41; E05Y 2900/544

(57) ABSTRACT

An apparatus allows movement of a closure for a vehicle in multiple directions, while also rotating about two different axes to avoid contact with another object of the vehicle. The apparatus may include multiple springs to counter the weight of the closure while opening the closure, as well as to provide lift assistance while closing the closure. The apparatus may further include a mount and a bracket that allow other components (e.g., shaft, springs) to rotate about two different axes.

### INTRODUCTION

Vehicles such as trucks and sport-utility vehicles may include a closure (e.g., tailgate). The closure can be opened to access a rear portion of the vehicle and subsequently closed to contain contents within the vehicle.

### SUMMARY

The subject technology is directed to an apparatus (e.g., support system) used to open and close a closure of a vehicle. The apparatus may include a shaft used to support a hinge when opening the closure. The apparatus may further include multiple springs, at least one of which supports the hinge when opening the closure and at least one of which supports the hinge when closing the closure. Additionally, the apparatus may include a mount and bracket that provide some components (e.g., the shaft and the springs) with multi-axis pivoting, which allows the assembly to rotate about two different axes. The multi-axis pivoting allows multiple degrees of freedom for the components of the apparatus. Beneficially, the apparatus can fit into a relatively small space in the vehicle, while also rotating about different axes to avoid contact with other objects in the vehicle.

The subject technology is directed to an apparatus (e.g., support system) used to open and close a closure of a vehicle. The apparatus may include a shaft used to support a hinge when opening the closure. The apparatus may further include multiple springs, at least one of which supports the hinge when opening the closure and at least one of which supports the hinge when closing the closure. Additionally, the apparatus may include a mount and bracket that provide some components (e.g., the shaft and the springs) with multi-axis pivoting, which allows the assembly to rotate about two different axes. The multi-axis pivoting allows multiple degrees of freedom for the components of the apparatus. Beneficially, the apparatus can fit into a relatively small space in the vehicle, while also rotating about different axes to avoid contact with other objects in the vehicle.

According to one or more aspects of the present disclosure, an apparatus is described. The apparatus may include a shaft configured to couple to a closure. The apparatus may further include a mount configured to couple to a vehicle. The apparatus may further include a bracket coupled to the mount and the shaft. The mount and the bracket form: a first joint configured to rotate the shaft about a first axis of rotation; and a second joint configured to rotate the shaft about a second axis of rotation. The first axis of rotation may be perpendicular to the second axis of rotation.

The apparatus may further include a first biasing component configured to provide a force to displace the closure in a first direction. The apparatus may further include a second biasing component configured to provide a force to displace the closure in a second direction different from the first direction. The shaft may be a dampener configured to counter the force in the first direction. The shaft may pass through the first biasing component. The shaft may pass through the second biasing component. The bracket may include an opening that receives the shaft, and the opening may be configured to allow the shaft to rotate about the second axis of rotation. The bracket may include a gimbal.

According to one or more aspects of the present disclosure, a vehicle is described. The vehicle may include a rear bumper. The vehicle may further include a hinge configured to rotate a closure around the rear bumper from a first position and a second position. The vehicle may further include an apparatus. The apparatus may include a shaft configured to couple to the closure. The apparatus may further include a mount configured to couple to a beam. The apparatus may further include a bracket coupled to the mount and the shaft. In one or more implementations, while the closure is displaced from the first position to the second position, the mount and the bracket cause the shaft to rotate about a first axis of rotation and a second axis of rotation. The mount and the bracket may form a first joint configured to rotate the shaft about a first axis of rotation. The mount and the bracket may further form a second joint configured to rotate the shaft about a second axis of rotation. The first axis of rotation may be perpendicular to the second axis of rotation.

The apparatus may further include a first biasing component configured to provide a force to displace the closure in a first direction. The apparatus may further include a second biasing component configured to provide a force to displace the closure in a second direction different from the first direction. The shaft may be configured to counter the force in the first direction. The shaft may pass through the first biasing component and the second biasing component.

The bracket includes an opening that receives the shaft, and the opening is configured to allow the shaft to rotate about the second axis of rotation. The bracket may include a gimbal. The shaft may be configured to rotate, about the first axis of rotation and the second axis of rotation, around a bin configured to carry a tire. The apparatus may further include a housing, and the shaft may pass through the housing. The closure includes a tailgate.

According to one or more aspects of the present disclosure, a method is described. The method may include providing a shaft configured to couple to a closure. The method may further include providing a mount configured to couple to a vehicle. The method may further include coupling a bracket to the mount and the shaft. The mount and the bracket may form a first joint configured to rotate the shaft about a first axis of rotation. The mount and the bracket may further form a second joint configured to rotate the shaft about a second axis of rotation.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates a side view of an example of a vehicle, in accordance with aspects of the present disclosure.

FIG. 2 illustrates a rear perspective view of a vehicle, in accordance with aspects of the present disclosure.

FIG. 3 illustrates a partial cross-sectional view of a rear portion of a vehicle, in accordance with aspects of the present disclosure.

FIG. 4 illustrates a partial cross-sectional view of a rear portion of a vehicle, showing a closure in a partially open position, in accordance with aspects of the present disclosure.

FIG. 5 illustrates a partial cross-sectional view of a rear portion of a vehicle, showing closure in an open position, in accordance with aspects of the present disclosure.

FIG. 6 illustrates a perspective view of an apparatus, in accordance with aspects of the present disclosure.

FIG. 7 illustrates a side view of an apparatus, showing the respective positions of components of the apparatus in a closed position of a closure of a vehicle, in accordance with aspects of the present disclosure.

FIG. 8 illustrates a side view of an apparatus, showing the respective positions of components of the apparatus in an open position of a closure of a vehicle, in accordance with aspects of the present disclosure.

FIG. 9 and FIG. 10 illustrate exemplary movement of an apparatus, in accordance with aspects of the present disclosure.

FIG. 11 and FIG. 12 illustrate bottom perspective views of the vehicle, showing exemplary movement of apparatus while avoiding contact with an object in the vehicle, in accordance with aspects of the present disclosure.

FIG. 13 illustrates a flow diagram showing a process for forming an apparatus, in accordance with one or more implementations of the present disclosure.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

This subject technology is directed to an apparatus (e.g., support system) for both lift assist and smooth opening for a closure of a vehicle. Due to various constraints (e.g., beams, bumper, tow hitch, etc.) of the vehicle, the apparatus may include a gimbal mount that allows the assembly to move (e.g., rotate) along different axes. For example, as the closure opens, the assembly rotates about a fixed point (first axis of rotation). Additionally, based on the gimbal mount, at least some components of the apparatus also rotate about another axis (second axis of rotation), thus allowing the apparatus to move around other objects in the vehicle, such as a bin for a spare time located on an underside of the vehicle. Beneficially, the apparatus provides a compact assembly that can fit into a relatively small space, while assisting a user in both opening and closing the closure. In one or more implementations, the gimbal mount includes a mount coupled (e.g., secured, fastened) with the vehicle and the bracket is coupled with the mount. Further, in one or more implementations, the first axis of rotation is perpendicular with respect to the second axis of rotation.

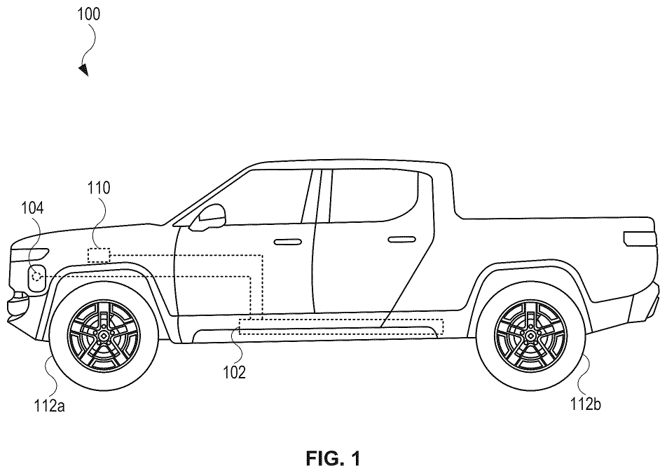

FIG. 1 illustrates a side view of an example of a vehicle 100, in accordance with aspects of the present disclosure. In one or more implementations, the vehicle 100 is a sport utility vehicle (SUV). In the example shown in FIG. 1, the vehicle 100 is a truck. Generally, the vehicle 100 may take the form of any motorized vehicle, including motorized vehicles with an internal combustion engine and/or one or more electric motors. Accordingly, some implementations of the vehicle 100 may include land-based vehicles, such as a car (e.g., sedan, hatchback), a van, or a commercial truck, as non-limiting examples.

The vehicle 100 may include a battery pack 102. The battery pack 102 may be coupled (e.g., electrically coupled) to one or more electrical systems of the vehicle 100 to provide power to the one or more electrical systems. The vehicle 100 may further include a port 104 (e.g., charge port) designed to receive a cable connector (not shown in FIG. 1) used to transmit power (e.g., alternating current (AC) power) that is converted to direct current (DC) power to charge the battery pack 102. The battery pack 102 may couple to a drive unit 110, representative of one or more drive units of the vehicle 100. While the drive unit 110 is shown as generally being in the front of the vehicle 100, the drive unit 110 may be located in the rear of the vehicle 100. Further, when multiple drive units are used, at least one drive unit may be in the front of the vehicle to drive the front wheels (e.g., wheel 112a), and at least one drive unit may be in the rear of the vehicle to drive the rear wheels (e.g. wheel 112b). The drive unit 110 may include, for example, a motor, an inverter, a gear box, and a differential. In the example shown in FIG. 1, the drive unit 110 takes the form of an electric motor. In this regard, the drive unit 110a may use energy (e.g., electrical energy) stored in the battery pack 102 for propulsion in order to rotationally drive the wheels 112a and 112b, representative of additional wheels, of the vehicle 100.

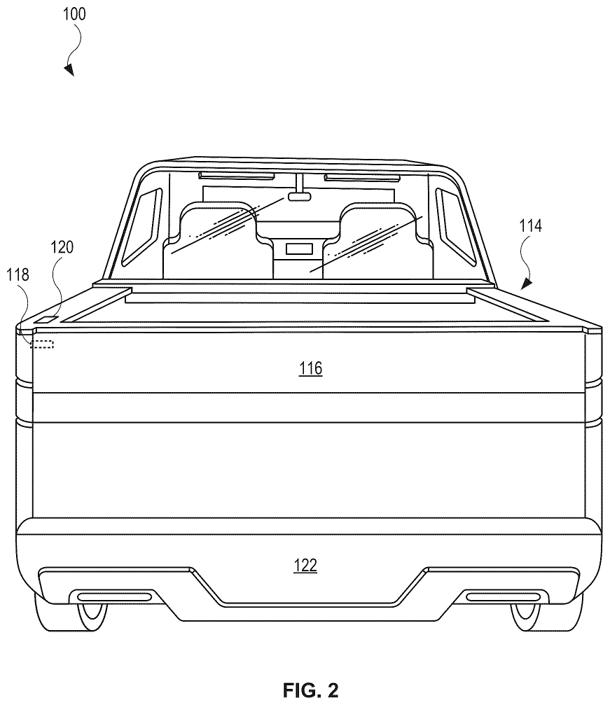

FIG. 2 illustrates a rear perspective view of a vehicle 100, in accordance with aspects of the present disclosure. The vehicle 100 may include a bed 114 that provides a storage area for the vehicle 100. The vehicle 100 may further include a closure 116 may be opened to access the bed 114, and subsequently closed to contain contents placed in the bed 114. In one or more implementations, the closure 116 takes the form of a tailgate of the vehicle 100.

In order to open the closure 116, the vehicle 100 may further include a latch 118, which may be representative of an additional latch, that holds and maintains the closure 116 in a closed position (shown in FIG. 2). The latch 118 may be actuated to release the closure 116, thus allowing the closure 116 to transition from the closed position to an open position. In this regard, the vehicle 100 may further include a button 120 that, when depressed, causes the latch 118 to release the closure 116. In one or more implementations, the latch 118 is an electronically controlled latch is actuated to release the closure 116 based on a control generated from various devices, such as a key fob or a software application (e.g., app) running on a mobile wireless communication device (e.g., smartphone). Additionally, the latch 118 may be controlled from an input from a touch display (not shown in FIG. 2) in the vehicle 100.

Also, the vehicle 100 may further include a bumper 122. Based on the location on the vehicle 100, the bumper 122 may be referred to as a rear bumper. The bumper 122 may provide a cover for one or more components used to facilitate displacement of the closure 116. This will be shown and described in further detail below.

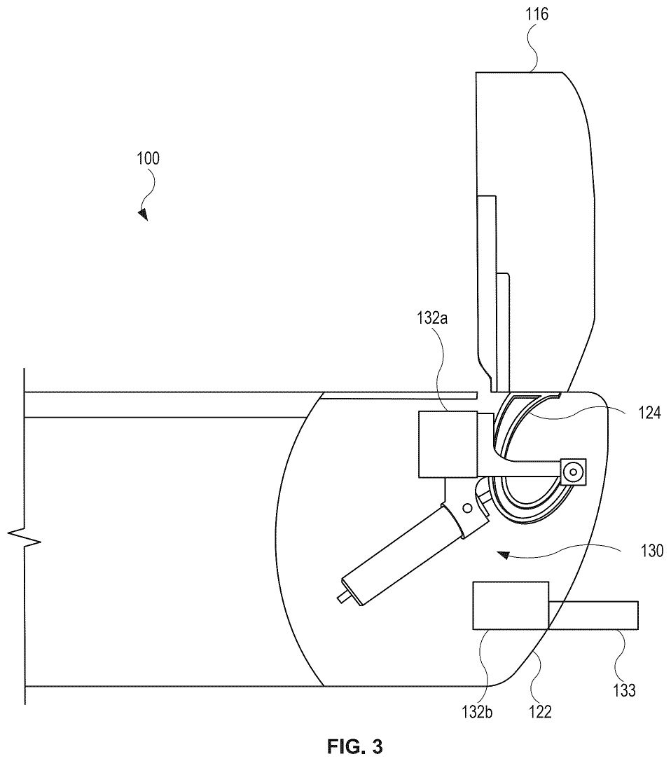

FIG. 3 illustrates a partial cross-sectional view of a rear portion of the vehicle 100, in accordance with aspects of the present disclosure. As shown, the closure 116 is in a closed position. The vehicle 100 may include a hinge 124 coupled (e.g., secured) with the closure 116. The hinge 124 may be used in part to open and close the closure 116. In one or more implementations, the hinge 124 takes the form of a gooseneck hinge. However, other forms of hinges are possible.

The vehicle 100 may further include an apparatus 130. In one or more implementations, the apparatus 130 includes components designed to facilitate displacement of the hinge 124, thus facilitating displacement of the closure 116. Additionally, the apparatus 130 is designed to fit into relatively small spaces. For example, as shown in FIG. 3, the apparatus 130 (as well as the hinge 124) may be positioned in the bumper 122, with the apparatus 130 coupled to a beam 132a located in the bumper 122. Additionally, the vehicle 100 may include a beam 132b that couples to a hitch 133 (e.g., tow hitch) of the vehicle 100. As shown, the apparatus 130 may be positioned between, or at least partially positioned between, the beams 132a and 132b. Also, while the apparatus 130 is transitioning the closure 116 from the closed position to the open position (or vice versa), one or more components of the apparatus 130 may rotate about multiple axes of rotation. This will be shown in further detail below.

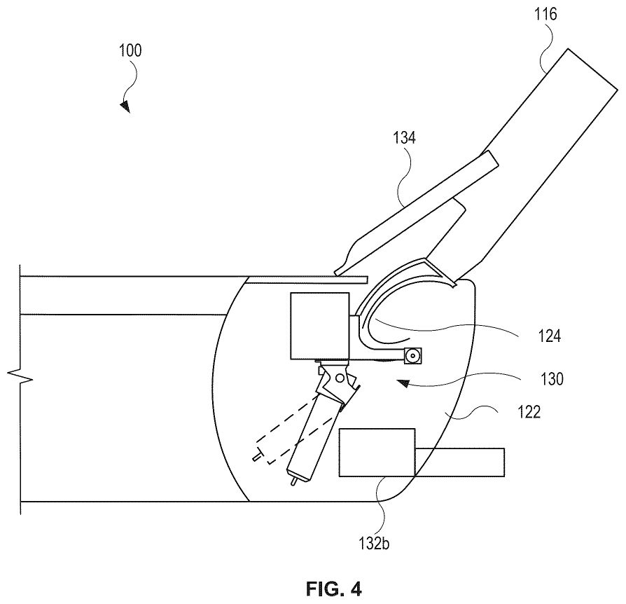

FIG. 4 illustrates a partial cross-sectional view of a rear portion of the vehicle 100, showing the closure 116 partially open, in accordance with aspects of the present disclosure. The partially open position may also be referred to as a partially closed position. The apparatus 130 and the hinge 124 may facilitate the additional displacement of the closure 116. The vehicle 100 may further include a panel 134 coupled to the closure 116. During a transition of the closure 116 from the closed position to the open position, the panel 134 may move or slide away from the closure 116 to cover or obscure the hinge 124 and the apparatus 130. Also, the apparatus 130 may be displaced relative to the position of the apparatus 130 when the closure 116 is in the closed position (shown in FIG. 3). For example, the dotted lines show the position of the apparatus 130 in the closed position of the closure 116. However, the apparatus 130 may avoid contact with the beam 132b.

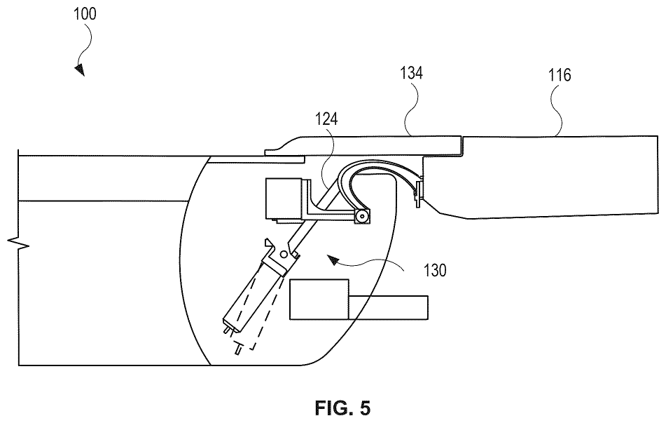

FIG. 5 illustrates a partial cross-sectional view of a rear portion of the vehicle 100, showing the closure 116 in an open position, in accordance with aspects of the present disclosure. As shown, the apparatus 130 and the hinge 124 facilitates additional displacement of the closure 116. Also, the panel 134 may further move or slide away from the closure 116 to continue to cover or obscure the hinge 124 and the apparatus 130. Also, the open position of the closure 116 may represent a fully open position in which the closure 116 is horizontal, or approximately horizontal. However, in some instances, the closure 116 may be further displaced past the horizontal position. Additionally, the apparatus 130 may be displaced relative to the position of the apparatus 130 when the closure 116 is in the partially open position (shown in FIG. 4). For example, the dotted lines show the position of the apparatus 130 in the partially open position of the closure 116. Based the multiple axes of rotation, the position of the apparatus 130 may be retracted as compared to the apparatus 130 when the closure 116 is partially open position.

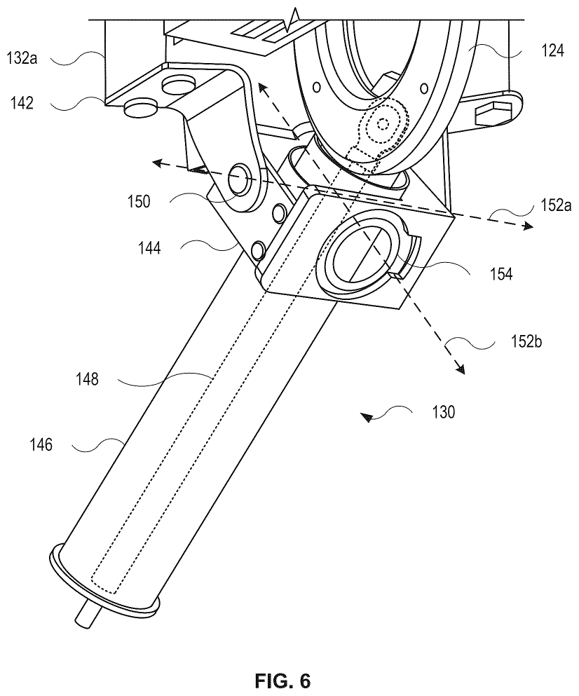

FIG. 6 illustrates a perspective view of the apparatus 130, showing several features of the apparatus 130, in accordance with aspects of the present disclosure. The apparatus 130 may include a mount 142. The mount 142 may be used to couple the apparatus 130 to components of a vehicle, such as the beam 132a.

The apparatus 130 may further include a bracket 144 coupled to the mount 142. In one or more implementations, the bracket 144 couples with and carries several components of the apparatus 130. For example, the apparatus 130 may further include a housing 146 coupled with the bracket 144. The housing 146 is designed to enclose, or at least partially enclose, additional components of the apparatus 130. For example, the apparatus 130 may further include a shaft 148 (partially shown as dotted lines) that extends through the housing 146 and couples to the hinge 124. In one or more implementations, the shaft 148 functions as a strut to provide resistance and counter the weight of the closure 116 (shown in FIG. 5) while the closure 116 is being opened. In this regard, the shaft 148 may function as a dampener. In this regard, the shaft 148 may include a substance (e.g., oil) designed to dampen movement of the closure 116 and control energy of one or more springs (not shown in FIG. 6) of the apparatus 130. Additionally, in one or more implementations, the shaft 148 functions as a dampener to counter the weight of the closure 116 (shown in FIG. 5) while the closure 116 is being closed.

At least one or more components of the apparatus 130 are rotatable about multiple axes of rotation. For example, the mount 142 and the bracket 144 couple together by a fastener 150 (representative of an additional fastener not shown in FIG. 5). As non-limiting examples, the fastener 150 may take the form of a pin, a rivet, or a bolt. Based on the fastener 150, the mount 142 and bracket 144 may form a joint that allows the bracket 144 to rotate, relative to the mount 142, about an axis of rotation 152a that extends through, or at least approximately through, the fastener 150. Based on the coupling between the bracket 144 and components such as the housing 146, the shaft 148, and springs (not shown in FIG. 6), the housing 146, the shaft 148, and springs are also rotatable about the axis of rotation 152a. Further, the bracket 144 may include a joint 154, representing an additional, second joint of the apparatus 130. In one or more implementations, the joint 154 takes the form of a gimbal. In this regard, the housing 146, the shaft 148, and springs are also rotatable about an axis of rotation 152b that extends through, or at least approximately through, the joint 154. Accordingly, multiple joints may be formed by the mount 142 and the bracket 144 to form multiple axes of rotation. In one or more implementations, the axis of rotation 152a is perpendicular to the axis of rotation 152b. In addition to the joint 154, other components may be used. For example, the joint 154 may be substituted by a ball and socket joint or a spherical joint.

Providing the apparatus 130 with multiple axes of rotation allows for several advantages. For example, the apparatus 130 may fit into relatively small spaces, such between the beams 132a and 132b as the bumper 122 (shown in FIG. 3), while being able to rotate in multiple directions. Additionally, the apparatus 130 may rotate around other objects in a vehicle without making unwanted contact with the object(s). Also, the apparatus 130 may simultaneously rotate about the axis of rotation 152a and the axis of rotation 152b. Accordingly, the apparatus 130 is capable of two degrees of freedom and is less susceptible to becoming bound or stuck. Beneficially, the apparatus 130 may experience less wear, which leads to longer use and a lower likelihood of breaking.

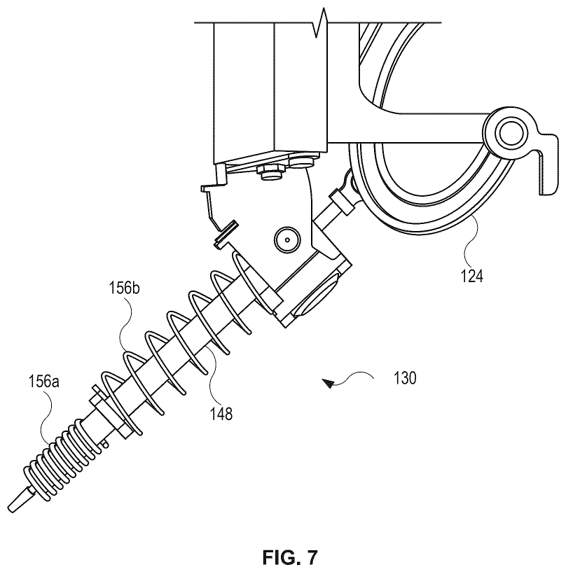

FIG. 7 illustrates a side view of the apparatus 130, showing the respective positions of components of the apparatus 130 in a closed position of the closure 116 (shown in FIG. 3), in accordance with aspects of the present disclosure. For purposes of illustration, the housing 146 (shown in FIG. 6) is removed from the apparatus 130. As shown, the shaft 148 is coupled to the hinge 124. The apparatus 130 may further include a biasing component 156a and a biasing component 156b. In one or more implementations, each of the biasing components 156a and 156b takes the form of a spring. As shown, the biasing component 156a is in a compressed state. In this regard, when the closure 116 is being opened, the biasing component 156a expands (e.g. to a decompressed state) and provides a force to facilitate opening the closure 116. Accordingly, while the biasing component 156a may provide a force to assisting in opening the closure 116, the shaft 148 may counter the force provided by the biasing component 156a, thus slowing the process of opening the closure 116.

Also, as shown, the biasing component 156b is expanded and in a decompressed state. In this regard, when the closure 116 is being opened, the biasing component 156b may compress and transition to a compressed state. However, when the closure 116 transitions from the open position (e.g., shown in FIG. 5) back to the closed position (e.g., shown in FIG. 3), the biasing component 156b transition back to the decompressed state. As a result, the apparatus 130 may use the biasing component 156b to provide lift assistance to the closure 116. Based on the functionality, the biasing component 156a may provide a force one in one direction that is used to open the closure 116, while the biasing component 156b may provide a force in another opposing direction. Additionally, in one or more implementations, the biasing component 156b combines with the biasing component 156a to provide additional force to open the closure 116. In one or more implementations, as shown in FIG. 7, the shaft 148 passes through the biasing component 156a and the biasing component 156b. Also, in one or more implementations, at least one of the biasing component 156a or the biasing component 156b takes the form of an air spring that relies on air pressure to balance the weight of the closure 116.

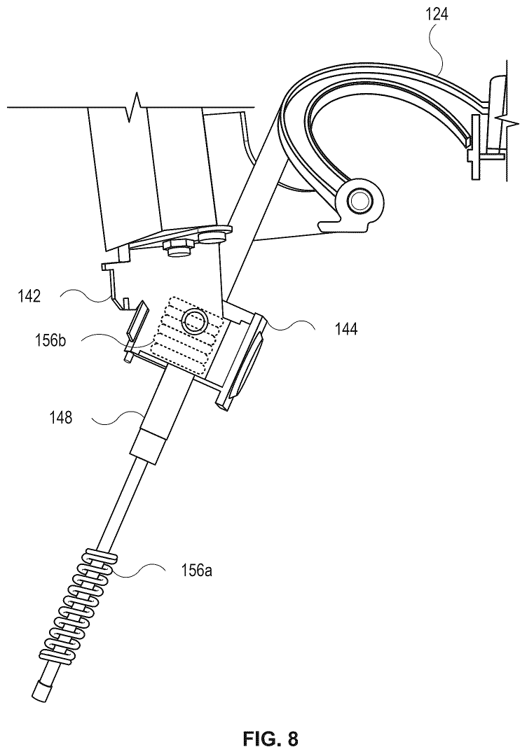

FIG. 8 illustrates a side view of the apparatus 130, showing the respective positions of components of the apparatus 130 in an open position of the closure 116 (shown in FIG. 5), in accordance with aspects of the present disclosure. When the closure 116 transitions to the open position, the hinge 124 is rotated with the closure 116. Additionally, based on the rotational movement of the hinge 124, the shaft 148 is actuated. Further, the bracket 144 may rotate relative to the mount 142. Also, the biasing component 156a expands to assist in opening the closure 116, while the biasing component 156b (shown as dotted lines) compresses. When the closure 116 is subsequently closed, the hinge 124 and the shaft 148 generally move in their respective opposite directions as compared to when the closure 116 is opened. Accordingly, the biasing component 156a again reduces to a compressed state and the biasing component 156b again expands to a decompressed state.

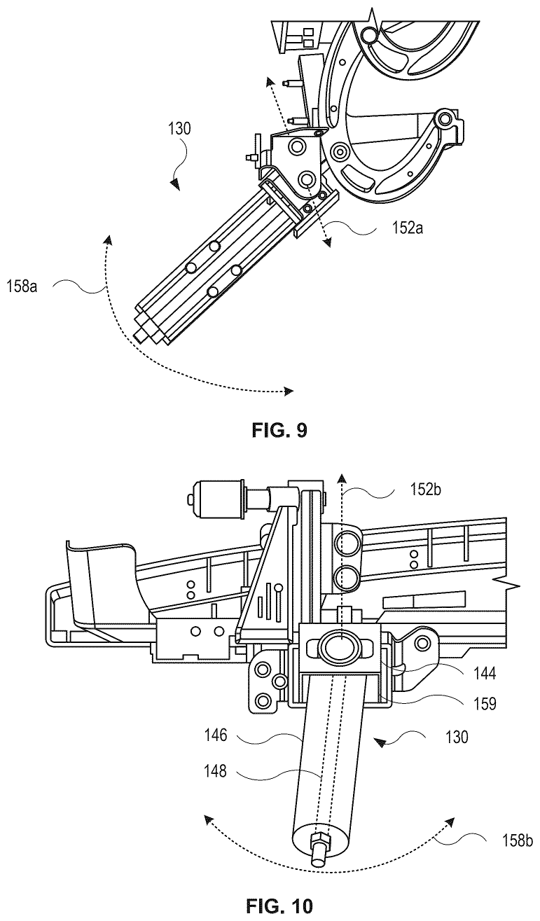

FIG. 9 and FIG. 10 illustrate exemplary movement of the apparatus 130, in accordance with aspects of the present disclosure. Referring to FIG. 9, during rotation of the closure 116 (shown in FIG. 4), the apparatus 130 may rotate about the axis of rotation 152a. The motion of the apparatus 130 is represented by a two-sided arrow 158a, indicating the apparatus 130 may rotate about the axis of rotation 152a in either direction of the two-sided arrow 158a based on opening or closing of the closure 116. Referring to FIG. 10, showing a bottom perspective view, during rotation of the closure 116 (shown in FIG. 4), the apparatus 130 may also rotate about the axis of rotation 152b. As shown, the bracket 144 includes an opening 159 through which the housing 146 and the shaft 148 pass. Based on the opening 159, including the size of the opening 159, the housing 146 and the shaft 148 is rotatable about the axis of rotation 152b in either direction of the two-sided arrow 158b. The motion of the apparatus 130 is represented by a two-sided arrow 158b, indicating the apparatus 130 may rotate about the axis of rotation 152b in either direction of the two-sided arrow 158b based on opening or closing of the closure 116. During a transition of the closure 116 from the closed position to the open position (or vice versa), the apparatus 130 may simultaneously rotate about the axis of rotation 152a and the axis of rotation 152b. In this regard, each position or angle of the closure 116 may define a unique position of the apparatus 130 in a three-dimensional space.

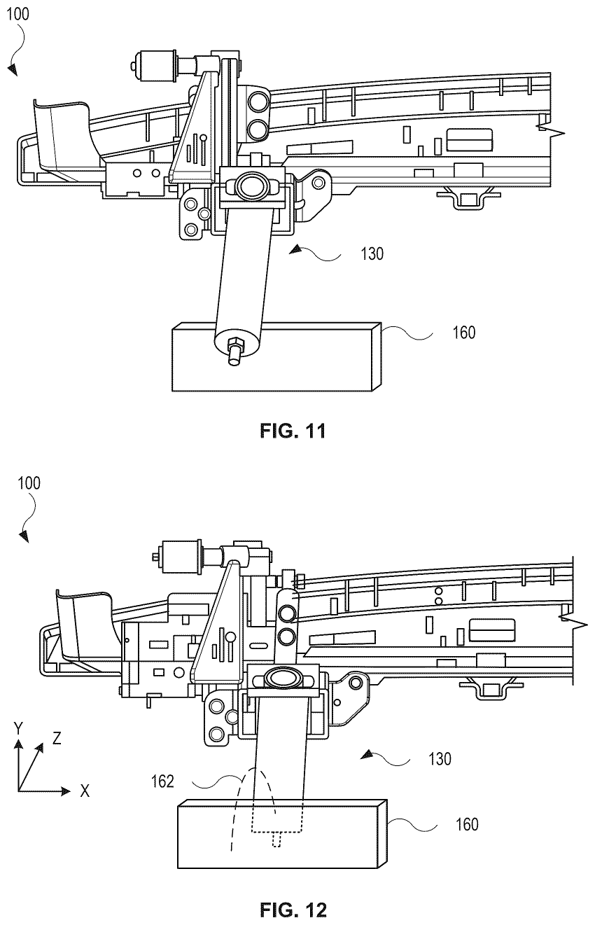

FIG. 11 and FIG. 12 illustrate bottom perspective views of the vehicle 100, showing exemplary movement of the apparatus 130 while avoiding contact with an object 160 in the vehicle 100, in accordance with aspects of the present disclosure. Referring to FIG. 11, the apparatus 130 is in the foreground while the object 160 is in the background. In one or more implementations, the object 160 takes the form of a bin used to carry a spare tire. However, other types of objects are possible. Further, a portion of the object 160 is shown in FIG. 11. Referring to FIG. 12, the apparatus 130 is rotated and positioned, or at least partially positioned, behind the object 160. The rotational movement of the apparatus 130 may be due in part to the closure 116 (not shown in FIG. 12) transitioning from the closed position (shown in FIG. 3) to the open position (shown in FIG. 5), or vice versa. Further, the dotted line 162 represents the motion of travel of the apparatus 130. Based on the multiple degrees of freedom of travel (due to the axis of rotation 152a and the axis of rotation 152b, both shown in FIG. 6), the motion of travel of the apparatus 130 may include a parabolic motion in the X-, Y-, and Z-axes (of Cartesian coordinates). Beneficially, the apparatus 130 accounts for the object 160, including the size, shape, and position of the object 160, thus avoiding contact with the object 160.

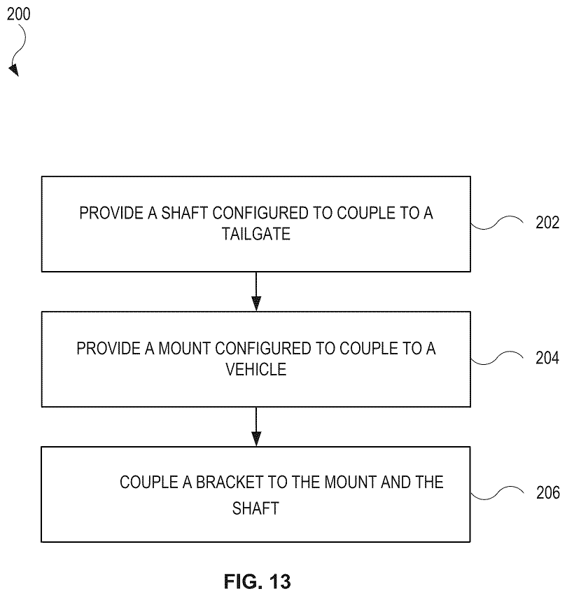

FIG. 13 illustrates a flow diagram showing an example of a process 200 that may be carried out for forming an apparatus, in accordance with implementations of the subject technology. For explanatory purposes, the process 200 is primarily described herein with reference to an apparatus, such as the apparatus 130 shown in FIGS. 3-12, as a non-limiting example. However, the process 200 is not limited to the apparatus 130, and one or more blocks (or operations) of the process 200 may be performed by one or more other structural components of other suitable moveable apparatuses, devices, or systems. Further for explanatory purposes, some of the blocks of the process 200 are described herein as occurring in serial, or linearly. However, multiple blocks of the process 200 may occur in parallel. In addition, the blocks of the process 200 need not be performed in the order shown and/or one or more blocks of the process 200 need not be performed and/or can be replaced by other operations.

At block 202, a shaft configured to couple to a closure is provided. The shaft may function as a strut to provide to counter the weight of the closure and provide a smooth opening of the closure. Additionally, one or more biasing components may be provided to provide assistance in opening and/or closing the closure. In one or more implementation, the shaft passes through the biasing components.

At block 204, a mount configured to couple to a vehicle is provided. The mount may couple to a beam of the vehicle, as a non-limiting example.

At block 206, a bracket is coupled to the mount and the shaft. The bracket and the mount may form a first joint configured to rotate the shaft about a first axis of rotation. The bracket and the mount may further form a second joint configured to rotate the shaft about a second axis of rotation. In this regard, a gimbal may be formed.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

When an element is referred to herein as being “connected” or “coupled” to another element, it is to be understood that the elements can be directly connected to the other element, or have intervening elements present between the elements. In contrast, when an element is referred to as being “directly connected” or “directly coupled” to another element, it should be understood that no intervening elements are present in the “direct” connection between the elements. However, the existence of a direct connection does not exclude other connections, in which intervening elements may be present.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other embodiments. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. An apparatus, comprising:
a shaft configured to couple to a closure;
a mount configured to couple to a vehicle; and
a bracket coupled to the mount and the shaft, wherein the mount and the bracket form:
a first joint configured to rotate the shaft about a first axis of rotation; and
a second joint configured to rotate the shaft about a second axis of rotation.

2. The apparatus of claim 1, wherein the first axis of rotation is perpendicular to the second axis of rotation.

3. The apparatus of claim 1, further comprising:
a first biasing component configured to provide a force to displace the closure in a first direction; and
a second biasing component configured to provide a force to displace the closure in a second direction different from the first direction.

4. The apparatus of claim 3, wherein the shaft is a dampener configured to counter the force in the first direction.

5. The apparatus of claim 3, wherein the shaft passes through the first biasing component.

6. The apparatus of claim 5, wherein the shaft passes through the second biasing component.

7. The apparatus of claim 1, wherein:
the bracket comprises an opening that receives the shaft, and
the opening is configured to allow the shaft to rotate about the second axis of rotation.

8. The apparatus of claim 1, wherein the bracket comprises a gimbal.

9. A vehicle, comprising:
a rear bumper;
a hinge configured to rotate a closure around the rear bumper from a first position and a second position; and
an apparatus comprising:
a shaft configured to couple to the closure;
a mount configured to couple to a beam; and
a bracket coupled to the mount and the shaft, wherein while the closure is displaced from the first position to the second position, the mount and the bracket cause the shaft to rotate about a first axis of rotation and a second axis of rotation.

10. The vehicle of claim 9, wherein the mount and the bracket form:
a first joint configured to rotate the shaft about a first axis of rotation; and
a second joint configured to rotate the shaft about a second axis of rotation.

11. The vehicle of claim 10, wherein the first axis of rotation is perpendicular to the second axis of rotation.

12. The vehicle of claim 9, wherein the apparatus further comprises:
a first biasing component configured to provide a force to displace the closure in a first direction; and
a second biasing component configured to provide a force to displace the closure in a second direction different from the first direction.

13. The vehicle of claim 12, wherein the shaft is a dampener configured to counter the force in the first direction.

14. The vehicle of claim 12, wherein the shaft passes through the first biasing component and the second biasing component.

15. The vehicle of claim 9, wherein:
the bracket comprises an opening that receives the shaft, and
the opening is configured to allow the shaft to rotate about the second axis of rotation.

16. The vehicle of claim 9, wherein the bracket comprises a gimbal.

17. The vehicle of claim 9, wherein the shaft is configured to rotate, about the first axis of rotation and the second axis of rotation, around a bin configured to carry a tire.

18. The vehicle of claim 17, wherein:
the apparatus further comprises a housing, and
the shaft passes through the housing.

19. The vehicle of claim 18, wherein the closure comprises a tailgate.

20. A method, comprising:
providing a shaft configured to couple to a closure;
providing a mount configured to couple to a vehicle; and
coupling a bracket to the mount and the shaft, wherein the mount and the bracket form:
a first joint configured to rotate the shaft about a first axis of rotation; and
a second joint configured to rotate the shaft about a second axis of rotation.
